(19) United States
(12) Patent Application Publication
(10) Pub. No.: US 2023/0284307 A1
(43) Pub. Date: Sep. 7, 2023

(54) METHOD AND SYSTEM FOR FACILITATING NETWORK CONNECTIVITY FOR UNCREWED AERIAL VEHICLES (UAVs)

(71) Applicant: AT&T Intellectual Property I, L.P., Atlanta, GA (US)

(72) Inventors: Zhi Li, Palo Alto, CA (US); Raghvendra Savoor, Walnut Creek, CA (US); Jin Wang, Fremont, CA (US)

(73) Assignee: AT&T Intellectual Property I, L.P., Atlanta, GA (US)

(21) Appl. No.: 17/686,705

(22) Filed: Mar. 4, 2022

(51) Int. Cl. H04W 76/16; H04W 76/34; B64C 39/02

(52) U.S. Cl. CPC H04W 76/16; H04W 76/34; B64C 39/024; G16Y 20/10

(57) ABSTRACT

Aspects of the subject disclosure may include, for example, a UAV communicatively coupling with a UAV controller over a first network, during a flight of the UAV, detecting availability of a device that is capable of providing network connectivity over a second network, based on the detecting the availability of the device, determining to communicatively couple with the device, responsive to the determining to communicatively couple with the device, submitting a request to the device for the network connectivity, and based on the submitting the request, establishing a communication session with the device to obtain the network connectivity. Other embodiments are disclosed.

### FIELD OF THE DISCLOSURE

The subject disclosure relates to facilitating network connectivity for uncrewed/unmanned aerial vehicles (UAVs).

### BACKGROUND

It has become increasingly popular to employ UAVs for remote-based missions and logistics operations, such as site inspections and physical deliveries of goods (e.g., food/supplies, packages, or other products). Typically, a UAV management platform or controller devises a flight plan that identifies a flight path for a UAV from a departure location to a destination location.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

With continued advances in technology, Internet-of-Things (IoT) devices, such as security cameras (which can capture video/audio in real-time), smart assistants, environmental sensors, etc., are now commonly found in many homes and businesses. These devices are usually installed within a user's premises or at/near a periphery of the premises—e.g., by a front door, a roof, or a window—and may be connected to the Internet, whether via a mesh network, Wi-Fi, or a cellular-based system.

As part of a UAV-based mission, the UAV may traverse a predetermined flight path from a departure location to one or more destination locations, while remaining communicatively coupled (over a network) with a UAV controller. It is possible, however, for the mission to be impacted, mid-flight, by network connection loss or degradation due to interference from external factors, such as unexpected weather conditions, physical construction work, or the like. A degraded or lost network connection can limit the ability of the UAV controller to continuously monitor and provide flight management for the UAV. Further, it would be helpful to be able to adjust the UAV's flight path to steer it away from any obstacles or unforeseen hazards in real-time.

The subject disclosure describes, among other things, illustrative embodiments of a UAV management system that is capable of leveraging network connectivity and/or other capabilities (e.g., real-time video/audio capture capabilities) of IoT device(s) to support UAV-based missions. In exemplary embodiments, the UAV management system may be configured to prearrange or coordinate with one or more IoT devices to provide network connectivity (e.g., access to the Internet) for a UAV during its flight.

In various embodiments, the IoT device(s) may be selected or identified based on their determined locations relative to a UAV's current or predefined flight path. For instance, the IoT device(s) may be selected or identified based on their being located along, or proximate to (e.g., within a threshold distance from), one or more portions of a predefined flight path of the UAV. In one or more embodiments, the IoT device(s) may be configured to detect/authorize the UAV (e.g., based upon determining that the UAV is located within the threshold distance from the IoT device(s), based upon receiving a request from the UAV, and/or the like), and to communicatively couple with the UAV (e.g., by establishing a peer-to-peer connection therewith) so as to share its network connectivity with the UAV. In this way, where the UAV happens to lose its (e.g., default network) connection, such as a cellular-based (or mobility) network connection or the like, one or more IoT device(s) or associated networks located along the flight path of the UAV can provide the UAV with the necessary connectivity.

In embodiments where the IoT device(s) include one or more security cameras/systems, the UAV controller and/or the UAV may analyze (e.g., in real-time or near real-time) data captured by such device(s) to identify/resolve issues encountered during the flight (such as, for example, damage to goods by individuals or natural occurrences, upcoming obstacles, etc.), utilize the analysis to adjust a flight path for the UAV, and/or assess overall mission effectiveness, as needed.

Leveraging the vastly available, connected home/business smart IoT devices and their capabilities and network connectivities, as described herein, enables a UAV— which may generally rely on a cellular-based network to communicate with a UAV controller during a mission—to remain connected to the UAV controller even in a case where the cellular-based connection is lost or degraded mid-flight. This enhances the safety, timeliness, accuracy, and reliability of UAV-based missions (whether for goods deliveries, inspections, or other operations) and improves the quality of UAV-based services and overall user/customer satisfaction.

The ability to create (e.g., temporary) network connections for a UAV using readily-available IoT devices, without a need for additional hardware installs/deployment, also enables simple and efficient adoption of the system, and provides smart device providers with opportunities to implement new service models along with their product offerings.

One or more aspects of the subject disclosure include an uncrewed aerial vehicle (UAV), comprising a processing system including a processor, and a memory that stores executable instructions that, when executed by the processing system, facilitate performance of operations. The operations can include communicatively coupling with a UAV controller over a first network. Further, the operations can include, during a flight of the UAV, detecting availability of a device that is capable of providing network connectivity over a second network. Further, the operations can include, based on the detecting the availability of the device, determining to communicatively couple with the device. Further, the operations can include, responsive to the determining to communicatively couple with the device, submitting a request to the device for the network connectivity. Further, the operations can include, based on the submitting the request, establishing a communication session with the device to obtain the network connectivity.

One or more aspects of the subject disclosure include a non-transitory machine-readable medium, comprising executable instructions that, when executed by a processing system of an uncrewed aerial vehicle (UAV) controller including a processor and communicatively coupled with a UAV over a first network, facilitate performance of operations. The operations can include arranging for a network of devices associated with a second network to provide network connectivity for the UAV, resulting in an arrangement. Further, the operations can include providing data regarding the arrangement to the UAV. Further, the operations can include communicating with the UAV during a flight of the UAV. Further, the operations can include, during the flight and responsive to a determination that the communicating has been negatively impacted, causing the UAV to initiate communications with the network of devices to obtain the network connectivity over the second network. Further, the operations can include, based on the causing, communicating with the UAV via the network connectivity over the second network.

One or more aspects of the subject disclosure include a method. The method can comprise receiving, by a processing system of an Internet-of-Things (IoT) device including a processor, a request to access a first network associated with the IoT device, wherein the request is submitted by a computing device while an uncrewed aerial vehicle (UAV) is in flight in accordance with a flight plan, and wherein the UAV is presently or previously communicatively coupled to a UAV controller over a second network. Further, the method can include, responsive to the receiving the request, determining, by the processing system, to grant the access to the UAV based on data provided by an operator of the second network or by a provider of the UAV. Further, the method can include, responsive to the determining to grant the access to the UAV, providing, by the processing system, connectivity between the UAV controller and the UAV over the first network, thereby enabling the UAV controller and the UAV to communicate with one another over the first network in relation to the flight plan.

Other embodiments are described in the subject disclosure.

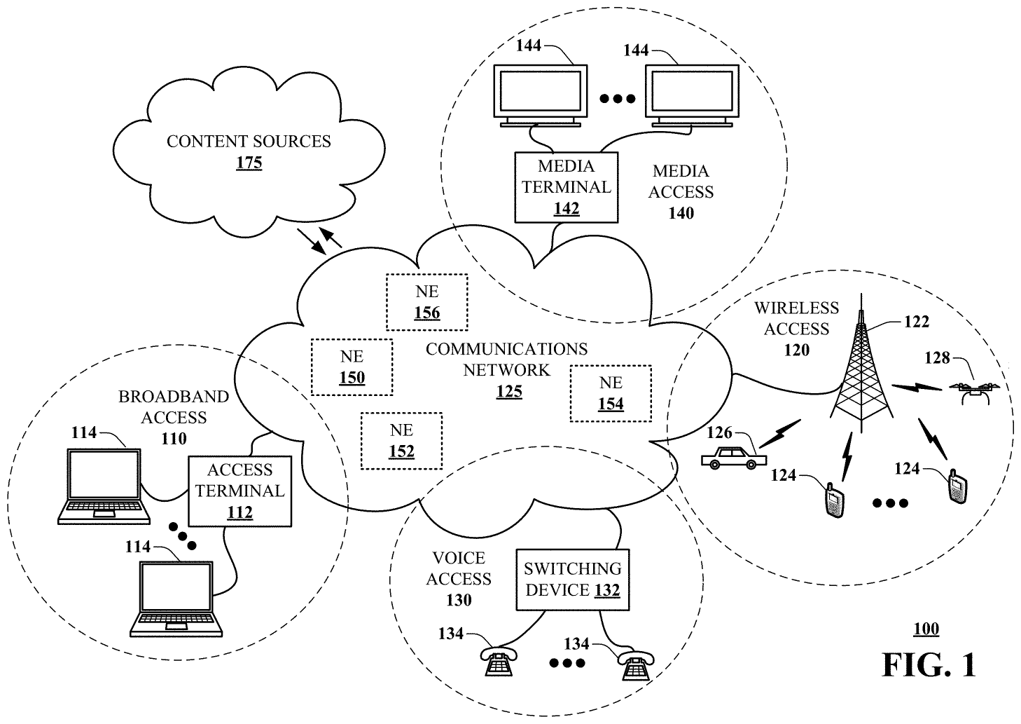

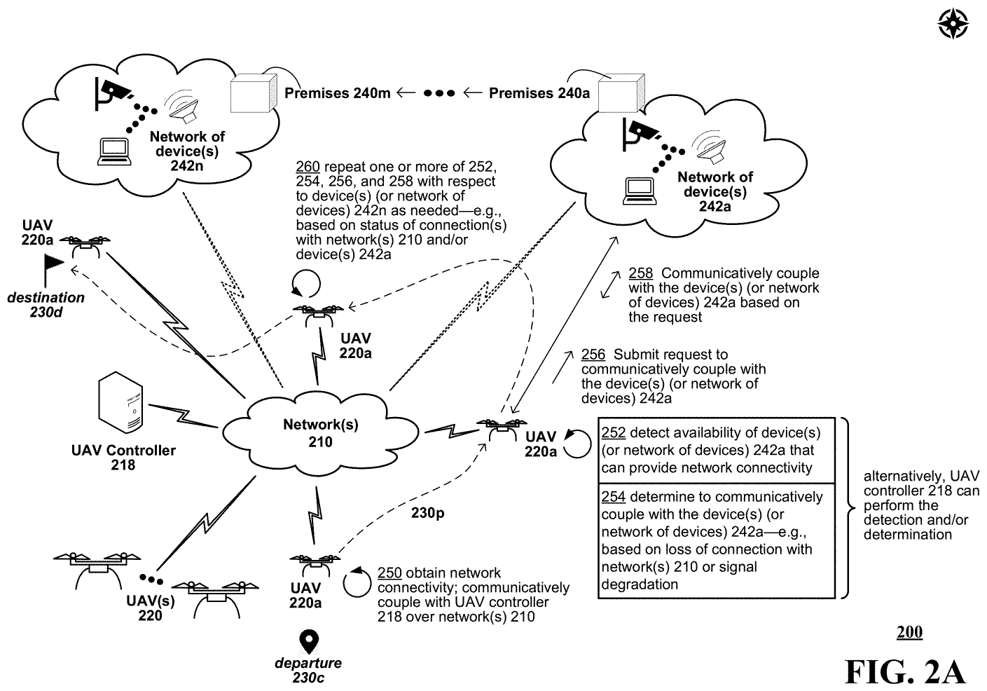

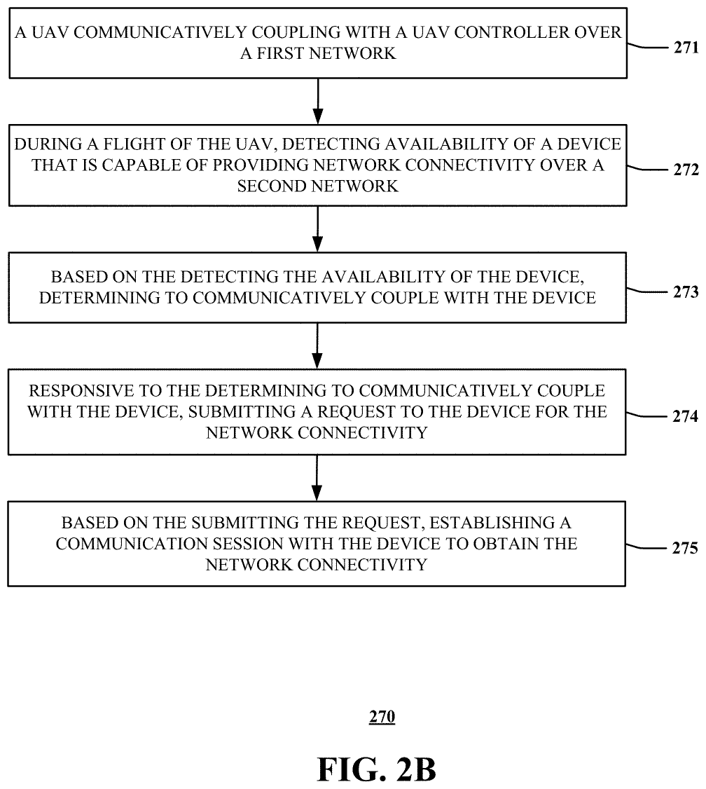

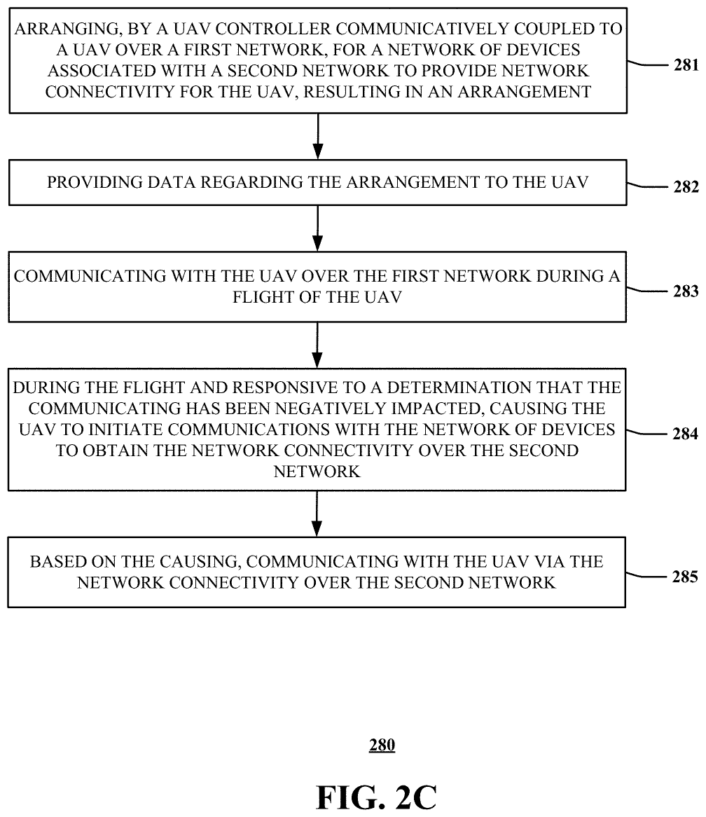

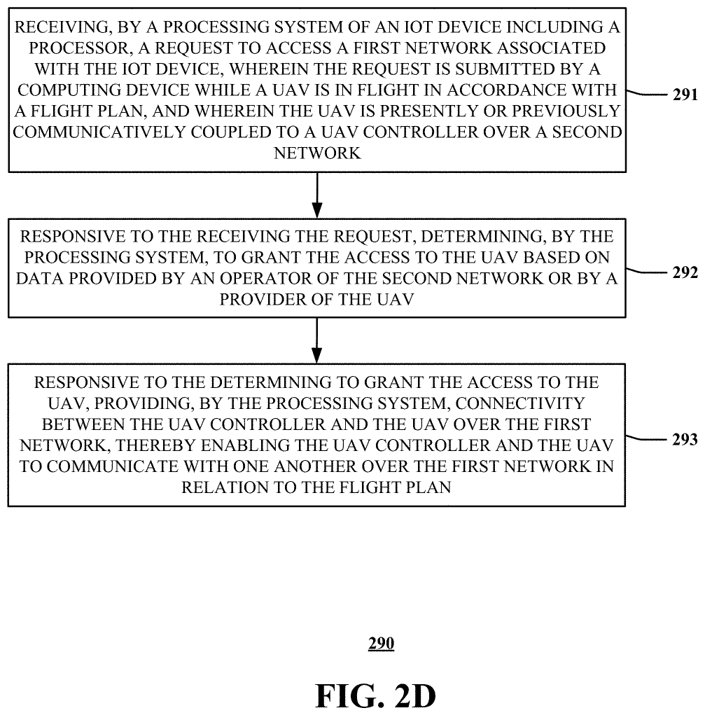

Referring now to FIG. 1, a block diagram is shown illustrating an example, non-limiting embodiment of a system 100 in accordance with various aspects described herein. For example, system 100 can facilitate, in whole or in part, arrangements for and/or provisioning of network connectivity for UAVs, as described elsewhere herein, such as with respect to FIG. 2A. In particular, a communications network 125 is presented for providing broadband access 110 to a plurality of data terminals 114 via access terminal 112, wireless access 120 to a plurality of mobile devices 124, vehicle 126, and UAV 128 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 2A is a block diagram illustrating an example, non-limiting embodiment of a UAV management system 200 configured to function in, or in conjunction with, various communication systems and networks, including, for example, the communications system 100 of FIG. 1, in accordance with various aspects described herein.

As shown in FIG. 2A, the UAV management system 200 may include a UAV management platform or controller 218, UAVs 220, and network(s) 210. The UAV controller 218 may be configured to perform route planning and/or flight management for one or more of the UAVs 220. A UAV 220 may include any personal or commercial aerial vehicle or device equipped with one or more types of devices or components for performing various actions. For example, a UAV 220 may include one or more radio equipment configured to function as a cellular relay, one or more sensors (e.g., image sensor(s), infrared sensor(s), near infrared camera(s), radar system(s), light detection and ranging (LIDAR) system(s), biological sensor(s), temperature sensor(s), chemical sensor(s), humidity sensor(s), and/or the like) for capturing information/data in an environment of the UAV 220, one or more mechanical limbs for physically manipulating external objects, and/or the like.

The network(s) 210 may include one or more wired and/or wireless networks. For example, the network(s) 210 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

Although not shown, in one or more embodiments, the network(s) 210 may include one or more network nodes or access points—e.g., base stations or the like—that each provides a radio access technology capable of facilitating communications between one or more devices (e.g., UAVs 220, device(s) 242a-242n, etc.) and one or more core networks. The UAV management system 200 may also include any number of edge systems/devices associated with such base stations. In certain embodiments, an edge system may correspond to, or be associated with, more than one base station. The particular functions performed by an edge system can vary based on various criteria or requirements of the network. In various embodiments, base stations and corresponding edge systems may be associated with (e.g., respective) cells, such as heterogeneous cells (e.g., that provide network access using different types of radio access technologies). In some embodiments, the cells can be terrestrial cells (e.g., one or more macrocells, small cells or microcells, Wi-Fi-based cell(s), or the like) or non-terrestrial cells (e.g., a flying cell, or drone cell, served by UAVs 220 or other UAVs). The UAV management system 200 can include various quantities of cells (e.g., primary cells and/or secondary cells), various quantities of base stations in a cell, and/or various types of base stations and/or cells. UAVs 220 can be located within cell coverage areas of the UAV management system 200, provided by cells associated with the various base stations, and may travel amongst various ones of the cells.

As shown in FIG. 2A, the UAV management system 200 may also include various premises 240a through 240m (m≥1) with respectively associated devices (or networks of devices) 242a through 242n (n≥1). A premises may be a residential home or business location, such as a single/multi-family house, apartment complex/building, apartment unit, commercial complex/building, commercial unit, etc. The devices (or networks of devices) 242a through 242n may include any devices that are configured with network connectivity. In exemplary embodiments, the devices (or networks of devices) may have access to the Internet via Wi-Fi, one or more mesh networks, one or more cellular-based systems, and/or the like, and may be capable of (directly or indirectly) communicating with the UAV controller 218 over network(s) 210 and/or other network(s). In one or more embodiments, some of the devices (or networks of devices) may be operated by the same operator/provider of some or all of the network(s) 210. For instance, a mobile network operator may provide a cellular-based network 210, and may additionally deploy device(s) (or network(s) of devices) in various regions to provide connectivity to the cellular-based network 210 via other radio access technologies, such as Wi-Fi.

In various embodiments, the devices 242a-242n may each include an IoT device, such as a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, an electrical switch controller, a door/lock controller (e.g., for a room door, a garage door, etc.), a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)), a similar type of device, a different type of device, or a combination of some or all of these devices.

In exemplary embodiments, the UAV management system 200 may be capable of leveraging network connectivity and/or other capabilities (e.g., real-time video/audio capture capabilities) of one or more of the devices (or networks of devices) associated with the various premises to support missions/operations of one or more of the UAVs 220.

As shown by reference number 250, a UAV 220a of the UAVs 220 may obtain (e.g., Internet) connectivity over the network(s) 210, and may be communicatively coupled to the UAV controller 218 via that connectivity. Here, the UAV 220a may be configured to carry out a mission or operation that involves traversing a flight path 230p from a departure location 230c to a destination location 230d. In various embodiments, the UAV 220a and the UAV controller 218 may communicate with one another over the network(s) 210 in relation to a flight plan, such as for effecting adjustments to the flight plan (e.g., changes to path(s) to be taken, changes to the destination location, changes in flight speed and/or elevation, etc.), exchanging flight-related data (e.g., data regarding a current location of the UAV 220a, data regarding a power status of the UAV 220a, signal strength data, etc.), and/or the like.

As shown by reference number 252, the UAV 220a may detect (e.g., during its flight) availability of device(s) (or network of devices) 242a that can provide network connectivity for the UAV 220a.

In various embodiments, the UAV controller 218 (or another associated device/system) may—e.g., as part of generating an initial flight plan for the UAV 220a—identify premises and/or their corresponding devices (or networks of devices), such as premises 240a, 240m, etc. and/or their corresponding devices (or networks of devices) 242a, 242n, etc., that are available to provide network connectivity for the UAV 220a.

In one or more embodiments, the UAV controller 218 may have access to a database that includes information regarding premises and/or their corresponding devices (or networks of devices). For each premises and/or its corresponding device(s) (or network of devices), the information may include, for example, data regarding a provider/operator/user associated with the premises, data regarding (e.g., respective) providers/operators of the corresponding device(s), data regarding a location of the premises, data regarding (e.g., respective) locations of the corresponding device(s), data regarding (e.g., respective or combined) signal coverage area(s) of the corresponding device(s) (or network of devices), data regarding capabilities of one of more of the devices, and/or identification data for one or more of the devices (or network of devices), such as a device identification (e.g., media access control (MAC) or serial) number, a network ID (e.g., a service set identifier (SSID)), etc. In certain embodiments, a provider/operator of a device, such as a smart home device provider or the like, may submit the some or all of the abovementioned information for inclusion in the database as part of an agreement by the smart home device provider to share network connectivity with UAVs. In some embodiments, a private residential or commercial user of a device may similarly submit device/network information for inclusion in the database as part of an agreement by the residential/commercial user to share network connectivity with UAVs.

In one or more embodiments, the UAV controller 218 may identify premises and/or their corresponding devices (or networks of devices) for network connectivity purposes based on their location(s) relative to flight paths in the flight plan. For instance, the UAV controller 218 may identify a premises and/or its corresponding device(s) (or network of devices) as being available to provide network connectivity for the UAV 220a if the location of that premises and/or one or more locations of its corresponding device(s) (or network of devices) is/are within threshold distance(s) from (e.g., a portion of) a flight path in the flight plan. In exemplary embodiments, the UAV controller 218 may, based upon identifying a premises and/or its corresponding device(s) (or network of devices), arrange for the device(s) (or network of devices) to facilitate provisioning of network connectivity for the UAV 220a. In various embodiments, the UAV controller 218 may perform the arrangement by communicating information regarding the UAV 220a and/or the flight plan to one or more identified device(s) (e.g., directly or indirectly via server(s)/hub(s) associated with the device(s)). The information may include, for example, a device identification number (e.g., a MAC address) associated with the UAV 220a, time period(s) during which the UAV 220a is expected (e.g., based on the flight plan/paths) to be located within a threshold distance from the identified device(s) (or network(s) of devices) (e.g., within the next fifteen minutes, between 12 PM and 12:15 PM on a certain date, etc.), data regarding network-related services or requirements needed for the UAV 220a (e.g., Internet connectivity, network port access requirements, network speed requirements, etc.), and/or the like. In some embodiments, the UAV controller 218 may encrypt the information prior to communicating the information to a given device and/or may employ authentication/tokens for facilitating the information exchange with the device. In this manner, the UAV controller 218 may perform preplanning of network connections for the UAV 220a along its flight path.

In exemplary embodiments, the UAV 220a may detect availability of the device(s) (or network of devices) 242a in one or more of a variety of ways. As one example, in a case where the UAV 220a monitors its location (whether from location data, such as GPS signals, or from information provided by the UAV controller 218) and where the location information for the device(s) 242a is prestored in the above-described database and is accessible to the UAV 220a (e.g., obtained periodically from the UAV controller 218 or received in a “location-based” manner in which location information for nearby premises/device(s) is transmitted to the UAV 220a based on a current location of the UAV 220a), the UAV 220a may detect the availability of the device(s) (or network of devices) 242a based on a comparison of the UAV 220a's location relative to the location(s) of the device(s) 242a. Here, for instance, the UAV 220a may detect availability of the device(s) (or network of devices) 242a based upon a determination that the UAV 220a is located within a threshold distance from the device(s) (or network of devices) 242a.

As another example, in a case where network ID information for the device(s) (or network of devices) 242a is prestored in the above-described database and is accessible to the UAV 220a (e.g., from the UAV controller 218), the UAV 220a may detect the availability of the device(s) (or network of devices) 242a based on detecting one or more (e.g., broadcast) signals that include the network ID information.

In some alternate embodiments, the UAV controller 218 may instead detect the availability of the device(s) (or network of devices) 242a. For instance, the UAV controller 218 may, as part of managing UAV 220a's flight, monitor the location of the UAV 220a based on location-related signals, such as GPS data or the like, provided by the UAV 220a, identify—e.g., according to information in the above-described database, such as location information, device capability data, etc.—that the UAV 220a is within a coverage area of (e.g., is within a threshold distance from) the device(s) (or network of devices) 242a, and accordingly determine that corresponding network connectivity is available for the UAV 220a.

As shown by reference number 254, the UAV 220a may (e.g., during its flight) determine to communicatively couple to the device(s) (or network of devices) 242a. In exemplary embodiments, the UAV 220a may perform the determination based on a status of current network connectivity of the UAV 220a. For instance, in a case where the UAV 220a is presently connected with the UAV controller 218 over a cellular-based network 210, the UAV 220a may determine a need to obtain network connectivity from the device(s) (or network of devices) 242a based upon detecting a loss of the cellular-based network connection and/or based upon detecting the strength of a related signal satisfying (e.g., falling to or below) a threshold level.

In certain embodiments, the UAV 220a may determine to communicatively couple to the device(s) (or network of devices) 242a regardless of a status of UAV 220a's present network connection. In these embodiments, the UAV 220a may seek to establish an additional network connection, which can provide connectivity redundancy and thus enhance mission reliability.

In some alternate embodiments, the UAV controller 218 may instead determine that the UAV 220a is to communicatively couple to the device(s) (or network of devices) 242a. For example, in the case where the UAV 220a is presently connected with the UAV controller 218 over a cellular-based network, the UAV controller 218 may determine a need for the UAV 220a to obtain network connectivity from the device(s) (or network of devices) 242a based upon detecting that communications between the UAV controller 218 and the UAV 220a are being negatively impacted. For instance, the UAV controller 218 may determine a need for the UAV 220a to obtain the network connectivity based upon detecting a loss of the cellular-based network connection and/or based upon detecting the strength of a related signal satisfying (e.g., falling to or below) a threshold level. In various embodiments, the UAV controller 218 may, based upon such a determination, cause the UAV 220a to initiate communications with the device(s) (or network of devices) 242a to obtain the network connectivity therefrom.

As shown by reference number 256, the UAV 220a may submit a request to communicatively couple with the device(s) (or network of devices) 242a. As shown by reference number 258, the UAV 220a may, based upon the request, communicatively couple with the device(s) (or network of devices) 242a. In exemplary embodiments, the device(s) (or network of devices) 242a may, upon receiving the request, determine whether the UAV 220a is authorized to communicatively couple with the device(s) (or network of devices) 242a, and may, based upon a determination that the UAV 220a is authorized to do so, establish connectivity with the UAV 220a or otherwise enable the UAV 220a to establish a communication session therewith. In one or more embodiments, a peer-to-peer connection may be established between the UAV 220a and the device(s) (or network of devices) 242a. The peer-to-peer connection may, for instance, be a Bluetooth-based connection, a Wi-Fi-based connection (e.g., Wi-Fi Direct), or any other type of peer-to-peer connection that is capable of facilitating Internet access for the UAV 220a.

In various embodiments, the device(s) (or network of devices) 242a may have access to a permission list or other (e.g., prestored) data that includes identification information—e.g., MAC addresses or other identification data—associated with individual UAVs 220 that are authorized to obtain network connectivity from the device(s) (or network of devices) 242a. The information/data for a given UAV 220 may be provided by an operator of the network(s) 210 and/or by a provider/operator of the UAV. In certain embodiments, in a case where the request submitted by the UAV 220a includes identification information regarding the UAV 220a, the device(s) (or network of devices) 242a may decide that the UAV 220a is authorized to communicatively couple therewith based on determining a match between the received identification information and the identification data stored in the permission list. In any case, by facilitating network connectivity for the UAV 220a during its flight, the UAV controller 218 may (e.g., continue to) communicate with the UAV 220a via the device(s) (or network of devices) 242a. Even in a situation where there might be a communication gap between the UAV controller 218 and the UAV 220a—such as in a case where the UAV 220a loses access to the network(s) 210 and is not able to immediately connect with a device (or network of devices) that can provide alternate network connectivity—the UAV controller 218 and the UAV 220a may nevertheless resume communications with one another when the UAV 220a later approaches an appropriate premises with available network connectivity. In some embodiments, the UAV controller 218 and/or the UAV 220a may, based upon the UAV 220a establishing a connection with the device(s) (or network of devices) 242a, disconnect from the (e.g., initial or main) connection between the UAV controller 218 and/or the UAV 220a over the network(s) 210, as needed (such as to conserve power resources of the UAV 220a).

As shown by reference number 260, one or more of the foregoing steps 252, 254, 256, and 258 may be repeated (e.g., as needed) with respect to device(s) (or network(s) of devices) associated with one or more other premises located along or near the flight path of the UAV 220a. For example, during a subsequent portion of UAV 220a's flight, the UAV 220a may communicatively couple with device(s) (or network of device(s) 242n of premises 240m) to obtain network connectivity as needed. In this way, the UAV 220a can be provided with ample means to remain connected to the UAV controller 218 throughout its journey from departure to destination (and throughout the UAV 220a's return journey as well, if required).

In various embodiments, the UAV 220a may, throughout its flight, gain access to devices of different premises and therefore obtain (e.g., simultaneous) network connectivity via multiple (e.g., peer-to-peer) connections. This can occur in a case where the UAV 220a traverses an area in which devices of different premises provide overlapping signal coverage and where the UAV 220a establishes a respective communication session with each of these devices.

In one or more embodiments, the UAV controller 218 may query for, obtain, and analyze UAV-related data from a device, such as a device 242a, 242n, etc. to identify/address flight issues as needed. For instance, in a case where the UAV controller 218 determines that a connection with the UAV 220a has been lost and seeks to locate the UAV 220a's whereabouts, the UAV controller 218 may (e.g., automatically or based upon detecting a command from an operator of the network(s) 210 or a provider of the UAV 220a) identify a nearby (e.g., security) camera device (e.g., within a threshold distance from a last known location of the UAV 220a), and query that nearby device for any video/audio data that it may have captured during a time period that encompasses a time at which the connection loss occurred. Here, the security camera device may, responsive to the query, retrieve a relevant portion of any captured video or audio footage (e.g., a portion that spans a threshold amount of time, such as ten seconds, thirty seconds, etc., before and/or after the time at which the connection loss occurred) and provide such footage to the UAV controller 218 for analysis.

In various embodiments, the UAV controller 218 and/or the UAV 220a may perform smart adjustments to a flight path (e.g., in real-time or near real-time) based on a variety of inputs, such as detected network failures (e.g., base station or edge system failures or congestion) along portions of the flight path, live video/audio feeds from camera(s) of the UAV 220a, and/or the like. In certain embodiments, the UAV controller 218 and/or the UAV 220a may additionally, or alternatively, utilize/analyze UAV-related data obtained from one or more devices, such as a device 242a, 242n, etc., as part of performing (e.g., real-time or near real-time) flight management for the UAV 220a. For instance, where a device captures video or audio data of its surroundings, the UAV controller 218 and/or the UAV 220a may obtain and analyze portions of such data to identify any obstacles, unforeseen weather conditions, etc. not accounted for in the (e.g., initial) flight plan, and may adjust the flight path of the UAV 220a accordingly to avoid any such obstacles/conditions.

In this way, residential or commercial resources, such as smart devices connected to the Internet via mesh network(s), Wi-Fi, etc., can be leveraged (e.g., in a service model) to support UAV operations with improved flight quality, security, and accuracy. Smart device/service providers (or even individual residential or commercial users) can partner, or become affiliated, with a mobile network operator to provide such support, whether for the mobile network operator's own UAVs or for UAVs of third-party customers or operators associated with the mobile network operator.

In one or more embodiments, the UAV management system 200 may be capable of performing load balancing of communications for UAVs by offloading portions of communications (e.g., different types of communications) to different networks or network connections based on one or more conditions being satisfied. As an example, in a case where the UAV controller 218 and/or the UAV 220a determines that the signal strength of communication signal(s) between the UAV controller 218 and the UAV 220a satisfies (e.g., has fallen to or below) a threshold level, and where one or more alternate network connectivities—such as, for example, provided via the device(s) (or network of devices) 242a, the device(s) (or network of devices) 242n, etc.—are available, the UAV controller 218 and/or the UAV 220a may cause various communication types to be balanced out (or spread) across the different network connections. Continuing the example, the UAV controller 218 and/or the UAV 220a may, for instance, cause UAV control signals to be communicated via network connectivity provided by the device(s) (or network of devices) 242a, low resolution video (e.g., captured by the UAV 220a for facilitating flight controls) may be communicated via network connectivity provided by the device(s) (or network of devices) 242m, high resolution video (e.g., captured by the UAV 220a for other purposes) may be communicated via network connectivity provided by another set of device(s) (or network of devices), and so on.

Although not shown in FIG. 2A, in some embodiments, one or more servers (e.g., implemented in the network(s) 210, such as in the form of the above-described edge system(s) or the like) may be configured to perform some or all of the abovementioned prearrangements of network connectivity for the UAV 220a's flight, perform (e.g., while the UAV is in flight) monitoring of the status of a network connection between the UAV controller 218 and the UAV 220a over the network(s) 210, identify when there is a need for alternate network connectivity for the UAV 220a based on the status (e.g., similar to that described above), submit access requests (e.g., on behalf of the UAV 220a and/or the UAV controller 218) to device(s) (or network(s) of devices) based on identified need for alternative network connectivity, and/or perform other actions (including, for example, switching of networks, etc.) to facilitate establishing of network connections between the UAV 220a and one or more devices (or network(s) of devices) as needed, all with or without involvement from the UAV controller 218 or the UAV 220a.

It is to be understood and appreciated that the quantity and arrangement of networks, devices, UAVs, and controllers shown in FIG. 2A are provided as an example. In practice, there may be additional networks, devices, UAVs, and/or controllers, fewer networks, devices, UAVs, and/or controllers, different networks, devices, UAVs, and/or controllers, or differently arranged networks, devices, UAVs, and/or controllers than those shown in FIG. 2A. For example, the system 200 can include more or fewer networks, devices, UAVs, and/or controllers, etc. In practice, therefore, there can be hundreds, thousands, millions, billions, etc. of such networks, devices, UAVs, and/or controllers. In this way, example system 200 can coordinate, or operate in conjunction with, a set of networks, devices, UAVs, and/or controllers and/or operate on data sets that cannot be managed manually or objectively by a human actor. Furthermore, two or more networks, devices, UAVs, or controllers shown in FIG. 2A may be implemented within a single network, device, UAV, or controller, or a single network, device, UAV, or controller shown in FIG. 2A may be implemented as multiple networks, devices, UAVs, or controllers. Additionally, or alternatively, a set of networks, devices, UAVs, or controllers of the system 200 may perform one or more functions described as being performed by another set of networks, devices, UAVs, or controllers of the system 200.

It is also to be understood and appreciated that, although FIG. 2A is described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein.

FIG. 2B depicts an illustrative embodiment of a method 270 in accordance with various aspects described herein. In some embodiments, one or more process blocks of FIG. 2B can be performed by a UAV, such as one of the UAVs 220. In some embodiments, one or more process blocks of FIG. 2B may be performed by another device or a group of devices separate from or including the UAV, such as the UAV controller 218, the network(s) 210, the device(s) (or network of devices) 242a, the device(s) (or network of devices) 242n, etc.

At 271, the method can include communicatively coupling with a UAV controller over a first network. For example, the UAV 220a can, similar to that described elsewhere herein, perform one or more operations that include communicatively coupling with a UAV controller over a first network.

At 272, the method can include, during a flight of the UAV, detecting availability of a device that is capable of providing network connectivity over a second network. For example, the UAV 220a can, similar to that described elsewhere herein, perform one or more operations that include, during a flight of the UAV, detecting availability of a device that is capable of providing network connectivity over a second network.

At 273, the method can include, based on the detecting the availability of the device, determining to communicatively couple with the device. For example, the UAV 220a can, similar to that described elsewhere herein, perform one or more operations that include, based on the detecting the availability of the device, determining to communicatively couple with the device.

At 274, the method can include, responsive to the determining to communicatively couple with the device, submitting a request to the device for the network connectivity. For example, the UAV 220a can, similar to that described elsewhere herein, perform one or more operations that include, responsive to the determining to communicatively couple with the device, submitting a request to the device for the network connectivity.

At 275, the method can include, based on the submitting the request, establishing a communication session with the device to obtain the network connectivity. For example, the UAV 220a can, similar to that described elsewhere herein, perform one or more operations that include, based on the submitting the request, establishing a communication session with the device to obtain the network connectivity.

In some implementations of these embodiments, the first network comprises a cellular-based network, and the second network comprises a mesh network, a Wi-Fi network, or another cellular-based network.

In some implementations of these embodiments, the method may include, responsive to the establishing the communication session with the device, causing a connection with the UAV controller over the first network to become disconnected.

In some implementations of these embodiments, the device comprises an Internet-of-Things (IoT) device. In some implementations of these embodiments, the IoT device comprises a security camera configured to capture video or audio data associated with at least a portion of the flight of the UAV, and to share the video or audio data with the UAV controller upon request.

In some implementations of these embodiments, the device is located at a customer premises.

In some implementations of these embodiments, the device is provided by a smart device provider different from an operator of the first network. In some implementations of these embodiments, the operator of the first network is affiliated with the smart device provider to facilitate use of the device for the network connectivity.

In some implementations of these embodiments, the detecting the availability of the device is based on a detection of a signal transmitted by the device or based on a determination that a current location of the UAV is within a threshold distance from a known location of the device.

In some implementations of these embodiments, the determining to communicatively couple with the device is based on a status of connectivity between the UAV and the UAV controller over the first network.

In some implementations of these embodiments, the network connectivity comprises access to an Internet.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C depicts an illustrative embodiment of a method 280 in accordance with various aspects described herein. In some embodiments, one or more process blocks of FIG. 2C can be performed by a UAV controller, such as the UAV controller 218. In some embodiments, one or more process blocks of FIG. 2B may be performed by another device or a group of devices separate from or including the UAV controller, such as one or more of the UAVs 220, the network(s) 210, the device(s) (or network of devices) 242a, the device(s) (or network of devices) 242n, etc. In certain embodiments, a non-transitory machine-readable medium may include executable instructions that, when executed by a processing system of the UAV controller including a processor, facilitate performance of operations, such as the various steps of method 280. In these embodiments, the UAV controller may be communicatively coupled with a UAV over a first network.

At 281, the method can include arranging for a network of devices associated with a second network to provide network connectivity for the UAV, resulting in an arrangement. For example, the UAV controller 218 can, similar to that described elsewhere herein, perform one or more operations that include arranging for a network of devices associated with a second network to provide network connectivity for the UAV, resulting in an arrangement.

At 282, the method can include providing data regarding the arrangement to the UAV. For example, the UAV controller 218 can, similar to that described elsewhere herein, perform one or more operations that include providing data regarding the arrangement to the UAV.

At 283, the method can include communicating with the UAV over the first network during a flight of the UAV. For example, the UAV controller 218 can, similar to that described elsewhere herein, perform one or more operations that include communicating with the UAV over the first network during a flight of the UAV.

At 284, the method can include, during the flight and responsive to a determination that the communicating has been negatively impacted, causing the UAV to initiate communications with the network of devices to obtain the network connectivity over the second network. For example, the UAV controller 218 can, similar to that described elsewhere herein, perform one or more operations that include, during the flight and responsive to a determination that the communicating has been negatively impacted, causing the UAV to initiate communications with the network of devices to obtain the network connectivity over the second network.

At 285, the method can include, based on the causing, communicating with the UAV via the network connectivity over the second network. For example, the UAV controller 218 can, similar to that described elsewhere herein, perform one or more operations that include, based on the causing, communicating with the UAV via the network connectivity over the second network.

In some implementations of these embodiments, the devices are located at a residential customer premises or a commercial customer premises.

In some implementations of these embodiments, the data regarding the arrangement comprises a device identification number or a service set identifier (SSID).

In some implementations of these embodiments, the network of devices comprises a mesh network or a Wi-Fi network.

In some implementations of these embodiments, the devices comprise one or more Internet-of-Things (IoT) devices.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D depicts an illustrative embodiment of a method 290 in accordance with various aspects described herein. In some embodiments, one or more process blocks of FIG. 2D can be performed by a device (or network of devices), such as device(s) (or network of devices) 242a, device(s) (or network of devices) 242n, etc. In some embodiments, one or more process blocks of FIG. 2D may be performed by another device or a group of devices separate from or including the device (or network of devices), such as one or more of the UAVs 220, the UAV controller 218, and/or the network(s) 210.

At 291, the method can include receiving, by a processing system of an Internet-of-Things (IoT) device including a processor, a request to access a first network associated with the IoT device, wherein the request is submitted by a computing device while an uncrewed aerial vehicle (UAV) is in flight in accordance with a flight plan, and wherein the UAV is presently or previously communicatively coupled to a UAV controller over a second network. For example, the device (or network of device) can, similar to that described elsewhere herein, perform one or more operations that include receiving, by a processing system of an Internet-of-Things (IoT) device including a processor, a request to access a first network associated with the IoT device. The request may be submitted by a computing device while an uncrewed aerial vehicle (UAV) is in flight in accordance with a flight plan, and the UAV may be presently or previously communicatively coupled to a UAV controller over a second network.

At 292, the method can include, responsive to the receiving the request, determining, by the processing system, to grant the access to the UAV based on data provided by an operator of the second network or by a provider of the UAV. For example, the device (or network of device) can, similar to that described elsewhere herein, perform one or more operations that include, responsive to the receiving the request, determining, by the processing system, to grant the access to the UAV based on data provided by an operator of the second network or by a provider of the UAV.

At 293, the method can include, responsive to the determining to grant the access to the UAV, providing, by the processing system, connectivity between the UAV controller and the UAV over the first network, thereby enabling the UAV controller and the UAV to communicate with one another over the first network in relation to the flight plan. For example, the device (or network of device) can, similar to that described elsewhere herein, perform one or more operations that include, responsive to the determining to grant the access to the UAV, providing, by the processing system, connectivity between the UAV controller and the UAV over the first network, thereby enabling the UAV controller and the UAV to communicate with one another over the first network in relation to the flight plan.

In some implementations of these embodiments, the IoT device comprises a security camera. In some implementations of these embodiments, the method may further include capturing, by the processing system, video or audio data associated with the UAV, and providing, by the processing system, at least a portion of the video or audio data to the operator of the second network or to the provider of the UAV based upon receiving a command from the operator or the provider.

In some implementations of these embodiments, the data identifies a media access control (MAC) address of the UAV, a time period during which the access is to be granted, or a combination thereof.

In some implementations of these embodiments, the computing device is included in the UAV, in the UAV controller, or in an external server separate from the UAV and the UAV controller.

In some implementations of these embodiments, the IoT device is provided by a smart home device provider that is different from the operator of the second network. In some implementations of these embodiments, the first network is associated with a plurality of IoT devices that includes the IoT device.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

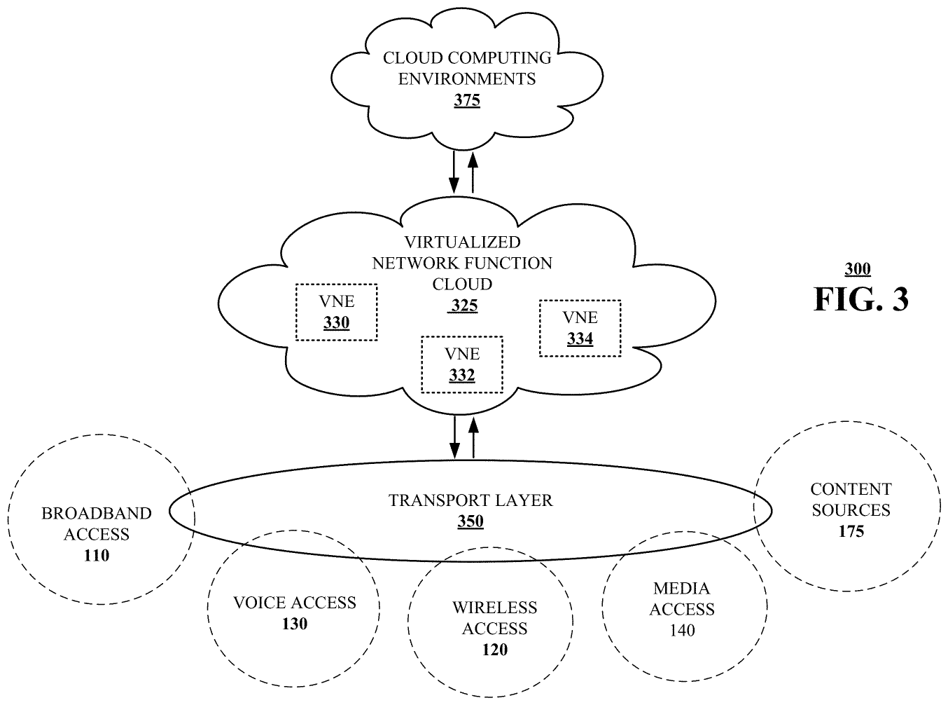

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and methods 270, 280, and 290 presented in FIGS. 1 and 2A-2D. For example, virtualized communications network 300 can facilitate, in whole or in part, arrangements for and/or provisioning of network connectivity for UAVs, as described elsewhere herein, such as with respect to FIG. 2A.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

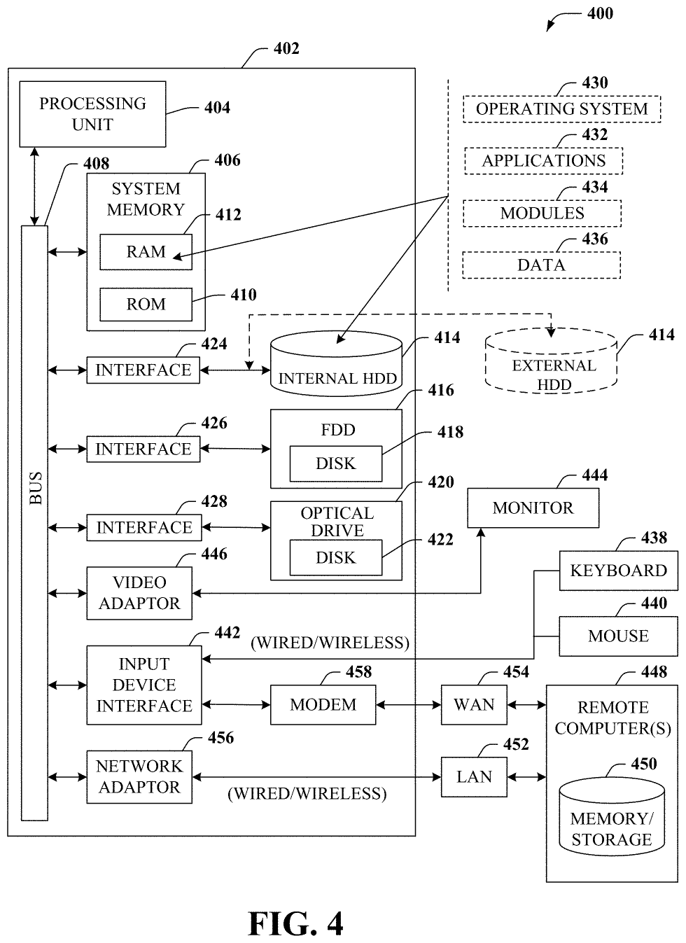

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, arrangements for and/or provisioning of network connectivity for UAVs, as described elsewhere herein, such as with respect to FIG. 2A.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

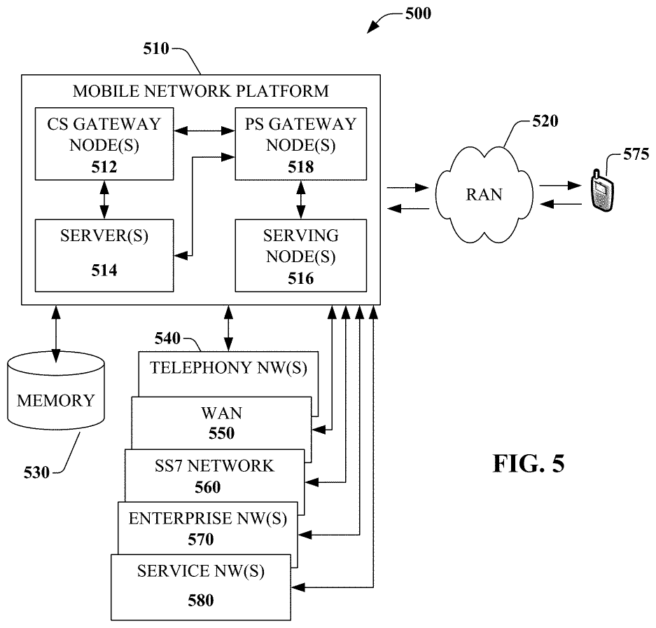

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, arrangements for and/or provisioning of network connectivity for UAVs, as described elsewhere herein, such as with respect to FIG. 2A. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

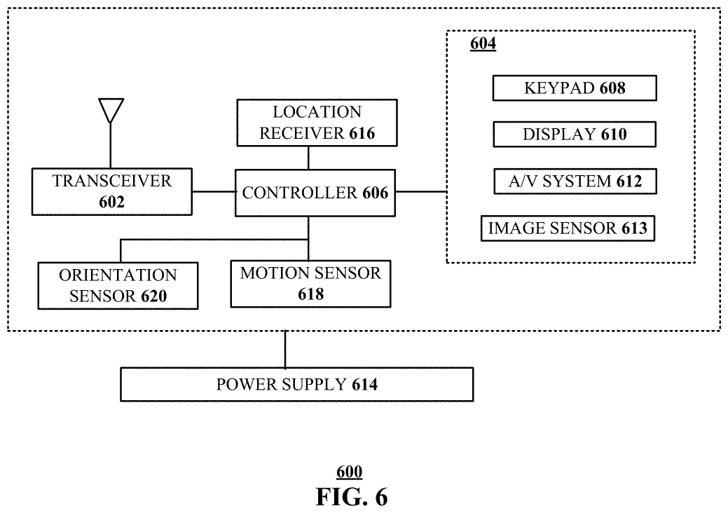

Turning now to FIG. 6, an illustrative embodiment of a communication device 600 is shown. The communication device 600 can serve as an illustrative embodiment of devices such as data terminals 114, mobile devices 124, vehicle 126, UAV 128, display devices 144 or other client devices for communication via communications network 125. For example, computing device 600 can facilitate, in whole or in part, arrangements for and/or provisioning of network connectivity for UAVs, as described elsewhere herein, such as with respect to FIG. 2A.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. An uncrewed aerial vehicle (UAV), comprising:
a processing system including a processor; and
a memory that stores executable instructions that, when executed by the processing system, facilitate performance of operations, the operations comprising:
communicatively coupling with a UAV controller over a first network;
during a flight of the UAV, detecting availability of a device that is capable of providing network connectivity over a second network;
based on the detecting the availability of the device, determining to communicatively couple with the device;
responsive to the determining to communicatively couple with the device, submitting a request to the device for the network connectivity; and
based on the submitting the request, establishing a communication session with the device to obtain the network connectivity.

2. The UAV of claim 1, wherein the first network comprises a cellular-based network, and wherein the second network comprises a mesh network, a Wi-Fi network, or another cellular-based network.

3. The UAV of claim 1, wherein the operations further comprise, responsive to the establishing the communication session with the device, causing a connection with the UAV controller over the first network to become disconnected.

4. The UAV of claim 1, wherein the device comprises an Internet-of-Things (IoT) device, and wherein the IoT device comprises a security camera configured to capture video or audio data associated with at least a portion of the flight of the UAV, and to share the video or audio data with the UAV controller upon request.

5. The UAV of claim 1, wherein the device is located at a customer premises.

6. The UAV of claim 1, wherein the device is provided by a smart device provider different from an operator of the first network.

7. The UAV of claim 6, wherein the operator of the first network is affiliated with the smart device provider to facilitate use of the device for the network connectivity.

8. The UAV of claim 1, wherein the detecting the availability of the device is based on a detection of a signal transmitted by the device or based on a determination that a current location of the UAV is within a threshold distance from a known location of the device.

9. The UAV of claim 1, wherein the determining to communicatively couple with the device is based on a status of connectivity between the UAV and the UAV controller over the first network.

10. The UAV of claim 1, wherein the network connectivity comprises access to an Internet.

11. A non-transitory machine-readable medium, comprising executable instructions that, when executed by a processing system of an uncrewed aerial vehicle (UAV) controller including a processor and communicatively coupled with a UAV over a first network, facilitate performance of operations, the operations comprising:
arranging for a network of devices associated with a second network to provide network connectivity for the UAV, resulting in an arrangement;
providing data regarding the arrangement to the UAV;
communicating with the UAV over the first network during a flight of the UAV;
during the flight and responsive to a determination that the communicating has been negatively impacted, causing the UAV to initiate communications with the network of devices to obtain the network connectivity over the second network; and
based on the causing, communicating with the UAV via the network connectivity over the second network.

12. The non-transitory machine-readable medium of claim 11, wherein the devices are located at a residential customer premises or a commercial customer premises.

13. The non-transitory machine-readable medium of claim 11, wherein the data regarding the arrangement comprises a device identification number or a service set identifier (SSID).

14. The non-transitory machine-readable medium of claim 11, wherein the network of devices comprises a mesh network or a Wi-Fi network.

15. The non-transitory machine-readable medium of claim 11, wherein the devices comprise one or more Internet-of-Things (IoT) devices.

16. A method, comprising:
receiving, by a processing system of an Internet-of-Things (IoT) device including a processor, a request to access a first network associated with the IoT device, wherein the request is submitted by a computing device while an uncrewed aerial vehicle (UAV) is in flight in accordance with a flight plan, and wherein the UAV is presently or previously communicatively coupled to a UAV controller over a second network;
responsive to the receiving the request, determining, by the processing system, to grant the access to the UAV based on data provided by an operator of the second network or by a provider of the UAV; and
responsive to the determining to grant the access to the UAV, providing, by the processing system, connectivity between the UAV controller and the UAV over the first network, thereby enabling the UAV controller and the UAV to communicate with one another over the first network in relation to the flight plan.

17. The method of claim 16, wherein the IoT device comprises a security camera, and wherein the method further comprises capturing, by the processing system, video or audio data associated with the UAV, and providing, by the processing system, at least a portion of the video or audio data to the operator of the second network or to the provider of the UAV based upon receiving a command from the operator or the provider.

18. The method of claim 16, wherein the data identifies a media access control (MAC) address of the UAV, a time period during which the access is to be granted, or a combination thereof.

19. The method of claim 16, wherein the computing device is included in the UAV, in the UAV controller, or in an external server separate from the UAV and the UAV controller.

20. The method of claim 16, wherein the IoT device is provided by a smart home device provider that is different from the operator of the second network, and wherein the first network is associated with a plurality of IoT devices that includes the IoT device.
